(19) United States
(12) Patent Application Publication
(10) Pub. No.: US 2018/0327260 A1
(43) Pub. Date: Nov. 15, 2018

(54) APPARATUS AND PROCESS FOR PRODUCTION OF SYNTHESIS GAS

(71) Applicant: CCP TECHNOLOGY GMBH, München (DE)

(72) Inventor: Olaf Kuhl, Greifswald (DE)

(21) Appl. No.: 15/770,224

(22) PCT Filed: Oct. 26, 2016
(86) PCT No.: PCT/EP2016/075815

§ 371 Date: Jul. 31, 2018

(30) Foreign Application Priority Data
Oct. 30, 2015 (DE) 10 2015 014 007.8

(51) Int. Cl. C01B 3/24; B01J 19/08

(52) U.S. Cl. CPC C01B 3/24; B01J 19/088; B01J 2219/0898; C01B 2203/1628; C01B 2203/0861; C01B 2203/1241; C01B 2203/1614; C01B 2203/0272

(57) ABSTRACT

An apparatus for producing synthesis gas at high capacity is described, wherein particularly fast conversion and operation for a long time without interruption is obtained. The apparatus comprises a reactor (1) having a reactor chamber (2) which comprises at least one first inlet (5) connected to a source of hydrocarbon fluid and at least one outlet (15); further a plasma burner (7) having a burner part (11) which is adapted to produce a plasma; and at least one second inlet (6) connected to a source of CO₂ or H₂O. The reactor chamber (2) defines a flow path from the first inlet (5) to the outlet (15), wherein the burner part is located, with respect to the flow path, between the first inlet (5) for hydrocarbon fluid and the second inlet (6) for CO₂ or H₂O; and wherein the second inlet (6) is located with respect to the flow path such that the second inlet (6) is at a location where between 90% and 95% of the hydrocarbon fluid is thermally decomposed. Further a method for operating an apparatus for producing synthesis gas is described.

### RELATED APPLICATIONS

This application corresponds to PCT/EP2016/075815, filed Oct. 26, 2016, which claims the benefit of German Application No. 10 2015 014 007.8, filed Oct. 30, 2015, the subject matter of which are incorporated herein by reference in their entirety.

### BACKGROUND OF THE INVENTION

The present invention relates to an apparatus and a method for producing synthesis gas.

From WO/2013/91878 a method for producing synthetic functionalized and/or non-functionalized hydrocarbons is known, the method comprising: decomposing a hydrocarbon-containing fluid into a H₂/C aerosol consisting of carbon C and hydrogen H₂ in a hydrocarbon converter, further directing at least a portion of the aerosol from the hydrocarbon converter into a C converter, and then introducing CO₂, e.g. from an industry process, into the C converter. In the C-converter, the CO₂ gas is mixed with the H₂/C-aerosol wherein the CO₂ gas and the carbon are converted into carbon monoxide CO at a high temperature. The temperature at the exit of the C-converter is about 800 to 1000° C. In a CO converter, the carbon monoxide and the hydrogen are converted into synthetic hydrocarbons by means of a catalyst.

In FIG. 4, a known plasma reactor 1′ (Kvaerner reactor) is shown, which has been used as a test reactor for producing carbon particles in the 1990s, and which is adapted for decomposing a hydrocarbon-containing fluid into a H₂/C aerosol, The plasma reactor 1′ has been used also for producing synthesis gas in a test operation. The known plasma reactor 1′ comprises a reactor chamber 2′ which is enclosed by a reactor wall 3′ having a lower part 3a′ and a cover 3b′. The reactor chamber 2′ is substantially cylindrical and has a central axis 4′. A plurality of inlets 5′ are provided on the cylindrical outer wall which are adapted to direct a hydrocarbon fluid and methane in the radial direction. A plasma burner 7′ comprising elongated electrodes is fixed to the cover 3b′ of the reactor wall 3′. The plasma burner T has a base part 9′ which is fixed to the cover 3b′ of the reactor wall 3′, At the other end thereof, opposite to the base part 9′, the plasma burner 7′ has a burner part 11′ which projects into the reactor chamber 2′. At the other end of the reactor chamber 2′ opposite the plasma burner 7′, the plasma reactor 1′ has an outlet 15′ through which the substances resulting from the decomposition of the incoming hydrocarbon fluid can exit. In operation of the known plasma reactor 1′, a plasma 13′ is formed in the vicinity of the burner part 11′. A hydrocarbon fluid and methane are introduced via the hydrocarbon fluids inlets 5′ in a direction towards the plasma 13′. The hydrocarbon and the methane are converted into synthesis gas at operating temperatures of up to 3500° C. A portion of the hydrogen gathers in the upper portion of the reactor chamber 2′. The rest of the hydrogen exits from the outlet 15′ together with the carbon monoxide, thus forming a synthesis gas. In a region between the plasma burner 7′ and the outlet 15′, there is a ripening zone, in which the C particles are formed. In the above mentioned apparatus of WO/2013/091878 such a plasma reactor 1′ is used in one embodiment for decomposing a hydrocarbon-containing fluid (hydrocarbon fluid) into a H₂/C aerosol. The H₂/C aerosol is then mixed with CO₂ in an outlet tube of the plasma reactor 1′, i.e. the outlet 15′, wherein CO is formed.

The following problems have been observed in the known plasma reactor. In the reactor chamber 2′ and at the inlets 5′ for hydrocarbon fluid, carbon deposits have been formed (fouling). The portion of the hydrogen which gathers in upper portion of the reactor chamber 2′ causes a substantial increase of temperature. The produced synthesis gas had a temperature between 1000 and 1300° C. at the outlet which caused a great loss of energy and made the known method uneconomical.

### SUMMARY OF THE INVENTION

The object of the present invention is to provide a high capacity apparatus for producing synthesis gas, which particularly provides fast conversion and long uninterrupted operation.

This object is achieved by an apparatus for producing synthesis gas according to claim 1 and by a method according to claim 9.

Particularly, this object is achieved by an apparatus for producing synthesis gas which comprises a reactor having a reactor chamber which comprises at least one first inlet connected to a source of hydrocarbon fluid and at least one outlet. The apparatus also comprises a plasma burner having a burner part adapted to produce plasma. Further, at least a second inlet connected to a source of CO₂ or H₂O leads into the reactor chamber. The reactor chamber defines a flow path from the first inlet to the outlet, wherein, with respect to the flow path, the burner part is located between the first inlet for hydrocarbon fluid and the second inlet for CO₂ or H₂O, and wherein the second inlet for CO₂ or H₂O is located with respect to the flow path such that the second inlet is at a location where between 90% and 96% of the hydrocarbon fluid is thermally decomposed. By means of this apparatus, a fast conversion into synthesis gas and reduced reaction times may be obtained since a stabile aerosol is present which comprises very small and easily floating C particles.

Particularly, the second inlet opens into the reactor chamber closer to the burner part than to the outlet. Thus, the conversion reaction of C and CO₂ into CO has sufficient time.

In one embodiment, the second inlet is oriented against the direction of the flow path and is directed towards the first inlet. Thus, a better blending of the gas introduced via the second inlet and the C particles is obtained, and carbon deposits are reduced.

Preferably, the apparatus comprises a third inlet which is, with respect to the flow path, further away from the burner part than from the second inlet. Therefore, different gases can be introduced during operation nearer to the burner part and further away from the burner part, and the production of synthesis gas can be better controlled. In this regard it is particularly advantageous if the second inlet is connected to a source of CO₂ and the third inlet is connected to a source of H₂O. When compared to the prior art, it is thus possible to obtain a lower temperature of the produced synthesis gas at the outlet of the apparatus. In order to further simplify control of the apparatus, a heating element may be provided between the at least one second inlet and the at least one third inlet. Thereby, the apparatus can be controlled kinetically and thermodynamically.

In one embodiment of the apparatus, the burner part comprises a plasma gas inlet connected to a source of plasma gas and a plasma gas outlet, wherein the plasma gas outlet opens into the reactor chamber. In this case, the inlet for hydrocarbon fluid is arranged with respect to the inlet for plasma gas such that the hydrocarbon fluid and the plasma gas are closely mixed with each other when entering into the reaction chamber.

In one embodiment of the apparatus, the plasma burner comprises at least two elongated electrodes, wherein each electrode comprises a base portion at one end, which is mounted to the reactor wall. The burner part is arranged at the end opposite to the base portion and extends into the reactor chamber. In this embodiment, the hydrocarbon fluid flowing along the reactor wall protects it against the heat of the plasma. In an alternative embodiment of the apparatus, the plasma burner is located outside of the reactor chamber and is connected to the reactor chamber via an opening in the reactor wall. In this case, the burner part is oriented towards the opening such that the plasma gas is guided into the reactor chamber. This embodiment provides more freedom for the construction of the plasma burner.

Further, the object is obtained by a method for producing synthesis gas comprising the following steps: introducing a hydrocarbon fluid into a reactor chamber which comprises at least one first inlet for hydrocarbon fluid and at least one outlet; producing a fluid flow from the inlet to the outlet; decomposing the hydrocarbon fluid into carbon particles and hydrogen with the aid of a plasma burner which is located between the inlet and the outlet; and mixing the carbon particles and the hydrogen with CO₂ or H₂O in a region in the reactor chamber where between 90% and 95% of the hydrocarbon fluid is thermally decomposed. With this method, a fast conversion into synthesis gas and reduced reaction times may be obtained since a stabile aerosol is present which has very small and easily floating C particles.

Particularly, the step of mixing with CO₂ or H₂O is carried out, with respect to the fluid flow, after the plasma burner in a region of the reaction chamber where the carbon particles have a size of equal to or smaller than 250 nm and preferably of equal to or smaller than 100 nm, Thereby the aerosol remains stable also at a substantial temperature decrease which is caused by the conversion reactions of the C particles with CO₂ or H₂O.

Alternatively or additionally, the method provides the step of mixing with CO₂ or H₂O in a region of the reactor chamber which is, with respect to the fluid flow, after the plasma burner where a temperature of 1550 to 1800° C. prevails. If this step is alternatively provided, the method can be controlled more easily. If this step is additionally provided, the method may be controlled more precisely.

In the method, the steps of mixing with CO₂ and mixing with H₂O are preferably carried out separately and one after the other in the direction of the fluid flow. When compared to the prior art, a lower temperature of the produced synthesis gas at the outlet of the apparatus becomes thus possible which provides for energy savings. Particularly, the carbon particles and the hydrogen are mixed with CO₂, with respect to the fluid flow, closer to the plasma burner and they are mixed with H₂O, with respect to the fluid flow, further away therefrom.

For accelerated reaction and increased throughput, the pressure in the reaction chamber is set to 10 to 25 bar.

The method is preferably carried out such that the synthesis gas comprises an amount of residual or not decomposed hydrocarbon fluid in a range from 1.25 to 2.6 mol-% in the region of the outlet. Thus, the measurement is facilitated. A measurement near the point of thermal decomposition of the hydrocarbon fluid is very difficult because of the high temperatures of more than 1000° C.

### BRIEF DESCRIPTION OF THE DRAWINGS

The invention as well as further details and advantages thereof are described in the following with the aid of preferred embodiments taken with reference to the figures.

FIG. 1 shows an apparatus for producing synthesis gas according to the present disclosure according to a first embodiment.

FIG. 2 shows an apparatus for producing synthesis gas according to the present disclosure according to a second embodiment.

FIG. 3 shows an apparatus for producing synthesis gas according to the present disclosure according to a third embodiment,

FIG. 4 shows a plasma reactor for decomposing a hydrocarbon fluid according to the prior art.

### DESCRIPTION

In the following description the terms top, bottom, right and left as well as similar terms relate to the orientations and arrangements shown in the figures and are meant for describing the embodiments. These terms may refer to preferred arrangements but are not meant to be limiting, In the context of this description the term hydrocarbon fluid means a fluid (gas, aerosol, liquid) which contains hydrocarbons.

FIG. 1 shows an apparatus for producing synthesis gas according to the present disclosure which comprises a plasma reactor 1 and sources for hydrocarbon fluid, for plasma gas and for CO₂ or H₂O which are not shown in detail in the figures. These sources include for instance tubes, storage tanks or other industry equipment.

The plasma reactor 1 comprises a reactor chamber 2 which is enclosed by a reactor wall 3 which comprises a lower part 3a and a cover 3b. The reactor chamber 2 can be divided also at a location different from that shown in the figures. The reactor chamber 2 is generally cylindrically and has a central axis 4. At the cover 3b of the reactor wall 3, a plasma burner 7 is mounted which comprises elongated electrodes (not shown in detail). The plasma burner 7 has a base part 9 which is fixed to the reactor wall 3 (here particularly at the cover 3b). At the other end thereof, opposite the base part 9, the plasma burner 7 has a burner part 11 which projects into the reactor chamber 2 and is located at the free end 12 of the electrodes. A plasma 13 is formed between the electrodes. At the other end of the reactor chamber 2, opposite the plasma burner 7, the plasma reactor 1 has an outlet 15 through which the substances which are produced inside the reactor chamber 2 can escape. The outlet 15 is located, seen in the direction of the flow, at the opposite end of the reactor chamber 2.

The plasma reactor 1 comprises one or more first inlets 5 for hydrocarbon fluid which are located near the base part 9 of the plasma burner 7. The first inlets 6 open into the reactor chamber 2 such that, during operation, a hydrocarbon fluid flowing therefrom flows into a space 17 between the reactor wall 3 and the electrodes of the plasma burner 7 in a direction towards the burner part 11. In the figures, the central axis 4 has an arrow head and indicates this direction of the flow. The reactor chamber 2 defines a flow path from the first inlets 6 to the outlet 15.

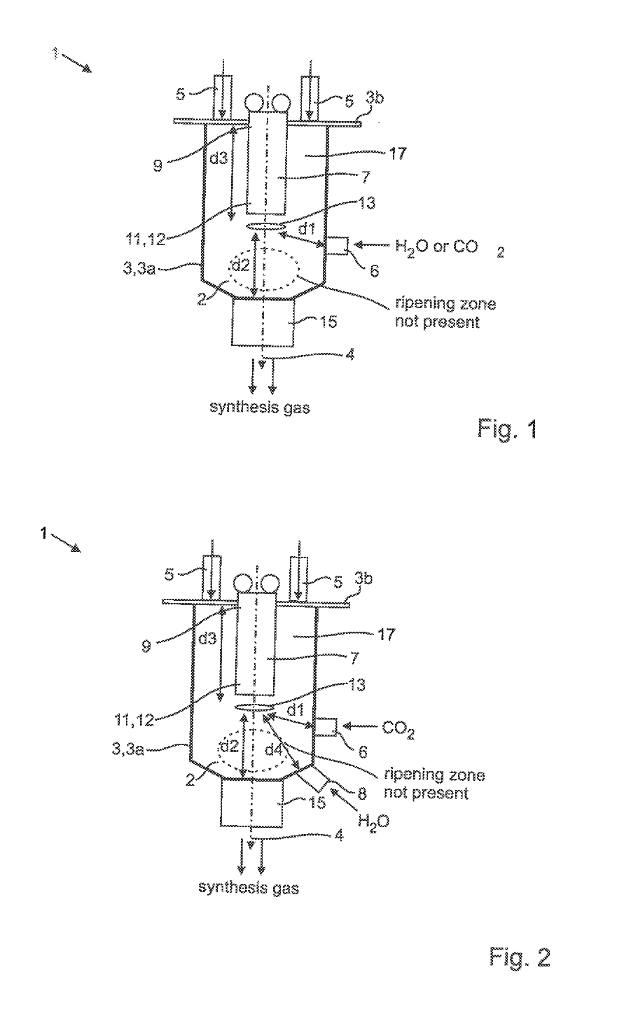

In the embodiment of FIG. 1, the plasma reactor 1 comprises one or more second inlets 6 for CO₂ or H₂O which open into the reactor chamber 2 at a location closer to the burner part 11 than to the outlet 15 (in FIG. 1 and 2: distance d1<d2). The second inlets 6 are located closer to the burner part 11 than the first inlets 5 (in FIGS. 1 and 2: distance d1<d3).

In operation, the second inlets 6 direct CO₂ or H₂O to a location in the reactor chamber where between 90% and 96% of the hydrocarbon fluid has been decomposed into hydrogen and C particles. The one or more second inlets 6 can be oriented in a right angle (as shown in FIGS. 1 and 2) or against the direction of the flow path, i.e. upwards as shown in the figures, towards the first inlets 5.

In the embodiment of FIG. 2, the plasma reactor 1 additionally comprises of one or more third inlets 8, which are located, along the flow path, further away from the burner part 11 than the second inlets 5 (in FIG. 2: distance d1<d4<d2). In FIG. 2, the second inlets 6 are connected to a source of CO₂ and the third inlets 8 are connected to a source of H₂O. Optionally, a heating element or heat exchanger for heating the reactor chamber 2 is located between the second inlets 6 and the third inlets 8.

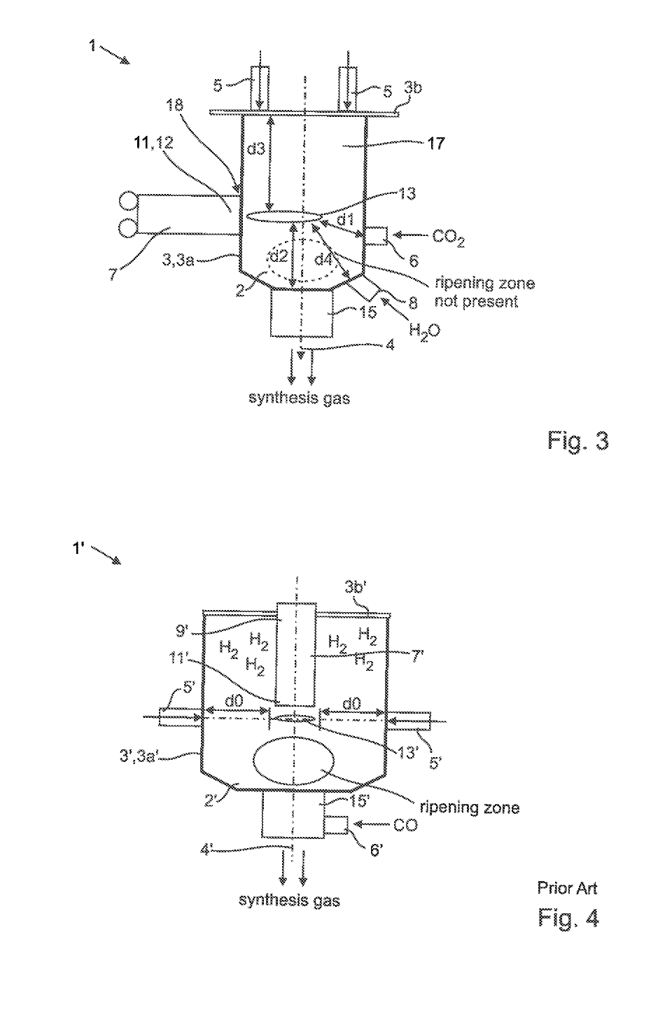

The apparatus shown in FIG. 3 corresponds to the embodiment of FIG. 2, but the plasma burner 7 has a different construction. In FIG. 3, the plasma burner 7 is located outside the reactor chamber 2 and is connected to the reactor chamber 2 via an opening 18 in the reactor wall 3. In this case, the burner part 11 is oriented towards the opening 18, such that hot plasma gas is directed into the reaction chamber 2.

The electrodes, which are not shown in detail in the figures, are e.g. nested tubular electrodes or tube electrode as known, e.g. from U.S. Pat. No. 5,481,080 A (see above). In the case of tubular electrodes, the introduced hydrocarbon fluid flows along one electrode, i.e. along the outer electrode. For tubular electrodes, the first inlets 5 are located radially outward of the outer tubular electrode. However, it is also envisaged that rod electrodes are used, such as two or more rod electrodes located next to each other. In the case of rod electrodes, the hydrocarbon fluid flows along two or more electrodes towards their free end. Thus, in each type of plasma reactor, the hydrocarbon fluid flows in the space 17 along at least one electrode between the reactor chamber 2 and the plasma burner 7. The plasma burner 7 has an inlet for plasma gas and an outlet for plasma gas which opens into the reactor chamber 2 near the burner part 11. Optionally, at least one of the first inlets 5 is located with respect to the inlet for plasma gas such that the hydrocarbon fluid and the plasma gas mix closely upon entering into the reaction chamber 2.

The plasma arc 13 is formed between the electrodes, preferably with CO, H₂O or synthesis gas as a plasma gas, since these gases are produced anyway in the apparatus and the method described herein. However, every other suitable gas may be chosen as a plasma gas, such as inert gases as argon or nitrogen, which do not have an influence on or participate in the reaction or decomposition, respectively, in the plasma arc. The inlet for plasma gas is connected with a source of plasma gas, e.g. a storage container. The source of plasma gas may be also the outlet 15 if synthesis gas is used as the plasma gas. If CO₂ or H₂ are used as a plasma gas, these gases may be extracted from the reactor chamber 2 at a suitable location or may be separated from the synthesis gas from the outlet 15.

One or more sensors may be provided at the plasma reactor so as to sense operation parameters (not shown in the figures). With the aid of pressure sensors, the pressure may be measured inside the reactor chamber 2, at the inlets 5, 6, 8, at the outlet 15 and in the sources for plasma gas, hydrocarbon fluid, CO₂ and H₂O. With the aid of temperature sensors, the temperature of the introduced substances, of the extracted substances and at different locations inside the reactor chamber 2 may be measured. With the aid of gas sensors, the composition of the introduced substances and of the produced synthesis gas may be measured.

The supply of CO₂ and H₂O can be controlled in a simple way by measuring the composition of the produced synthesis gas. The amount, size, position and orientation of the inlets 6 with respect to the burner part 11 and the operation parameters for introducing CO₂ or H₂O, such as pressure and amount introduced per time, are chosen in one embodiment depending on the amount of residual or not decomposed hydrocarbon fluid in the synthesis gas in the region of the outlet 15. Particularly, the location of the inlets 6 and the operation parameters are chosen such that the synthesis gas comprises an amount of residual or not decomposed hydrocarbon fluid in a range of 1.25 to 2.5 mol-%. This operation is contrary to the prior art, where no residual or not decomposed hydrocarbon fluid in the synthesis gas is desired. Alternatively, the location of the inlets 6 and the operation parameters are chosen such that CO₂ or H₂O is introduced into the reaction chamber 2 where a temperature of 1550 to 1800° C. prevails. With respect to the fluid flow, the inlets 6 are located after the burner part 11 of the plasma burner 7.

During operation of the apparatus for producing synthesis gas, a plasma 13 is formed in the plasma reactor 1 between the electrodes near the burner part 11. The plasma 13 usually has temperatures between 5.000° C. and 10.000° C. The heat is transferred mainly by radiation to the media (gases) inside the reactor. A hydrocarbon fluid (preferably methane or natural gas) is fed into the reactor chamber 2 via the first inlets 5 for hydrocarbon fluid in a direction towards the plasma 13, wherein oxygen is excluded. In the apparatuses according to FIGS. 2 and 3, the hydrocarbon fluid flows along the plasma burner 7. In the apparatus according to FIG. 3, the hydrocarbon fluid does not flow along the plasma burner 7, but hot plasma gas is introduced into the reactor chamber 2 via the opening 18, wherein the hydrocarbon fluid passes the plasma 13. Catalysts are not provided. In operation, the hydrocarbon fluid is introduced such that a high space velocity (unit 1/hour; volumetric flow rate m³/h of the hydrocarbon fluid divided by the volume m³ of the reactor chamber 2) is obtained in the reactor chamber 2. Particularly, a space velocity of 500-1000 1/h is considered. Due to the high space velocity and the corresponding high flow rate of the substances passing through, the risk of deposits of solids on the first inlets 5 and near to them is reduced. The location of the first inlets 5 causes a fluid flow towards the outlet 15 on the opposite end of the reactor chamber 2, which also prevents that hot substances accumulate in the space 17 and lead to problems during operation.

As soon as the hydrocarbon fluid comes to a region near the plasma 13 where a decomposition temperature prevails, the hydrocarbons contained in the hydrocarbon fluid will be decomposed into C particles and gaseous hydrogen H₂. For instance the hydrocarbon fluid CH₄ is decomposed into C and 2 H₂. The decomposition temperature depends on the supplied hydrocarbons and is e.g. more than 600° C. for natural gas or CH₄. With respect to the direction of the fluid flow after the burner part 11 of the plasma burner 7, the hydrogen H₂ and the C particles are present as a H₂/C aerosol. The H₂/C aerosol is mixed with CO₂ or H₂O coming from the second inlets 6 in a region in the reactor chamber 2 where between 90% and 95% of the hydrocarbon fluid is thermally decomposed. This region is near the burner part 11, so that the ripening zone, which is provided in the prior art, is not present in this case. Near the burner part 11, a high temperature of 800 to 3000° C. prevails in the reactor chamber 2. As soon as CO₂ is supplied via the second inlets 6, the C particles are converted in this temperature range according to the equation C+CO₂═2 CO. If H₂O is supplied via the second inlets 6, the C particles are converted in this temperature range according to the equation C+H₂O→CO+H₂. The above mentioned reactions are executed without catalysts.

The above mentioned conversion reactions proceed fast and completely if small C particles are mixed with CO₂ or H₂O. With the prior art plasma reactor 1′ shown in FIG. 4, C particles could be produced already with a size of about 350 nm. However, the prior art did not yet disclose how even smaller C particles could be produced. The inventors found that very small C particles having a size of equal to or less than 250 nm to 100 nm are present in a reactor chamber 2 where 90% to 95% of the hydrocarbon fluid is thermally decomposed. Therefore, CO₂ or H₂O is supplied to this region so as to obtain high reaction rates with the present apparatus and method.

According to one embodiment of the invention, the skilled person can set the supply of CO₂ or H₂O depending on an amount of residual or not decomposed hydrocarbon fluid in the synthesis gas in the region of the outlet 15. The supply of CO₂ or H₂O depends on the number, size, position, and orientation of the second inlets 6 relative to the burner part 11 and from operation parameters such as pressure and supplied mass per time of the supply. Particularly, the location of the inlets 6 and the operation parameters are chosen such that the synthesis gas has an amount of residual or not decomposed hydrocarbon fluid in a range of 1.26 to 2.5 mol-%. This approach is contrary to the prior art, where no residual or not decomposed hydrocarbon fluid is present in the synthesis gas. Alternatively, the skilled person selects the location of the inlets 6 and the operation parameters such that the introduction of CO₂ or H₂O takes place in a region of the reactor chamber 2 where a temperature of 1550 to 1800° C. prevails, which is measured by a temperature sensor or another high temperature measuring method. In the region where CO₂ or H₂O are supplied, the C particles have a size of equal to or less than 250 nm, preferably equal to or less than 200 nm and particularly preferable of equal to or less than 100 nm, which leads to a fast conversion reaction and to a stabile aerosol. Malfunctions and deposits (fouling) can be avoided.

During operation of the apparatus of FIG. 1, which does not comprise the third inlets 8, CO₂ or H₂O is supplied via the second inlets. Preferably, CO₂ is supplied. When 1 mol CH₄ is supplied, 1 mol C and 2 mol H₂ are generated by the decomposition with the aid of the plasma. The 1 mol C and the 1 mol CO₂ are converted to 2 mol CO. In this case, 4 mol synthesis gas are produced from 1 mol CH₄. If e.g. 10% of the supplied CH₄ is not converted, the synthesis gas has a CH₄ amount of 2.5 mol % at the outlet 15. The skilled person can calculate the corresponding amount of not decomposed hydrocarbon fluid according to the corresponding calculation also for other hydrocarbon fluids, e.g. if the supplied hydrocarbon fluid is natural gas and comprises amounts of other gases (e.g. ethane, propane, butane, ethene and so on).

During operation of the apparatus of FIG. 2, which comprises both the second inlets 6 as well as the third inlets 8, CO₂ is supplied via the second inlets 6 and H₂O is supplied via the third inlets 8, and both are mixed with the aerosol of C particles and H₂ or CO/H₂ respectively. In the course of the flow path from the burner part 11 to the outlet 15, there is a temperature decrease of about 1000° C.: The CO₂ supplied via the second inlets 6 is less than would be necessary for a complete conversion of the C particles into CO. The CO₂ is supplied in such an amount that about 25 to 40%, preferably one third, of the mass of a C particle is converted into CO. During the conversion of C and CO₂ into CO (Boudouard reaction), there is a temperature decrease of about 500° C. (50% of the total temperature decrease). Since the C particles in the region of the introduction of CO₂ are smaller than in the known plasma reactor of FIG. 4 (about 350 nm), the aerosol of C particles, CO, H₂ and the residual hydrocarbon fluid remains stable despite the substantial temperature decrease of about 500° C. Such an amount of H₂O is supplied via the third inlets 8 that the rest of the C particles (75 to 60%, preferably two thirds) is converted into CO (hetWSR or heterogene Watergas-Shift-Reaction: C+H₂O→CO+H₂). Here a further temperature decrease of about 500° C. occurs. Thus, the temperature at the outlet 15 is lower than during operation of the apparatus in FIG. 1.

The operation of the apparatus of FIG. 3 is basically the same as described above for FIG. 2. Different from FIG. 2, the hydrocarbon fluid does not flow along the plasma burner 7 but passes the plasma burner. The plasma gas is supplied to the plasma burner 7 with such a pressure and such a flow rate that the plasma 13 is blown into the reactor chamber 2. The pressure of the supplied plasma gas is preferably higher than the pressure of the supplied hydrocarbon fluid.

The following features can independently be applied for all apparatuses of FIGS. 1 to 3. The supply of CO₂ or H₂O through the one or more second inlets 6 can be carried out based in a measured temperature. The temperature measurement can be used alternatively to the above mentioned method where the amount of residual hydrocarbon fluid is measured, or the temperature measurement can be used in addition so as to improve the accuracy. The pressure in the reactor chamber 2 is set to 10 to 25 bar. In one case, the plasma burner 7 is generally inside the reactor chamber 3. Alternatively, the plasma burner 7 is outside the reactor chamber 2, and the plasma gas heated by the plasma burner 7 flows during operation into the reactor chamber 2 via a tube. The one or more second inlets are at a location of 0-3 m and preferably at a location of 0-1 m downstream of the location where at least 90% of the hydrocarbon fluid has been decomposed into C particles and hydrogen. Therefore, mixing of CO₂ or H₂O takes place at a location of 0-3 m and preferably at a location of 0-1 m downstream of the location where at least 90% of the hydrocarbon fluid has been decomposed into C particles and hydrogen. The step of mixing the CO₂ or H₂O begins in a region of the reactor chamber where the carbon particles have a size of equal to or less than 260 nm, preferably equal to or less than 200 nm and particularly preferably equal to or less than 100 nm in diameter. Both CO₂ and H₂O can be supplied into the reactor chamber 2, and the introduction of CO₂ and the introduction H₂O are carried out separately and one after the other.

It may be summarized that the following benefits can be obtained by the above described apparatus and method: deposits of C particles can be avoided; a stabile aerosol can be obtained also at substantial temperature decreases; fast conversion and reduced reaction time; compared to the prior art, lower temperature of the produces synthesis gas.

The invention has been described based on preferred embodiments, wherein individual features of the described embodiments may be combined freely and/or may be substituted as far as these features are compatible. Furthermore, individual features of the described embodiments may be omitted as long as these features are not essential. Thus, those skilled in the art will appreciate that various modifications and practical implementations are possible and obvious without departing from the full and fair scope of the present invention.

1. Apparatus for producing synthesis gas which comprises:
a reactor (1) having a reactor chamber (2) which comprises at least one first inlet (5) connected to a source of hydrocarbon fluid and at least one outlet (15);
a plasma burner (7) having a burner part (11) adapted to generate a plasma;
at least one second inlet (6) connected to a source of CO₂ or H₂O; wherein the reactor chamber (2) defines a flow path from the at least one first inlet (5) to the at least one outlet (15), wherein the burner part (11) is located, with respect to the at least one flow path, between the at least one first inlet (5) for hydrocarbon fluid and the at least one second inlet (6) for CO₂ or H₂O; and
wherein the second inlet (6) is located, with respect to the flow path, such that the at least one second inlet is at a location where between 90% and 95% of the hydrocarbon fluid thermally is decomposed.

2. Apparatus according to claim 1, wherein the at least one second inlet (6) opens into the reactor chamber closer to the burner part (11) than to the at least one outlet (15).

3. Apparatus according to claim 1, wherein the at least one second inlet (6) is located closer to the burner part (11) than the at least one first inlet (5).

4. Apparatus according to claim 1, wherein the at least one second inlet (6) is oriented against the direction of the flow path and is oriented towards at least one the first inlet (5).

5. Apparatus according to claim 1, which comprises a at least one third inlet (8) which is, with respect to the flow path, further away from the burner part (11) than the at least one second inlet.

6. Apparatus according to claim 5, wherein the at least one second inlet (6) is connected to a source of CO₂: and wherein the at least one third inlet (8) is connected to a source of H₂O.

7. Apparatus according to claim 5, wherein a heating element is located between the at least one second inlet (6) and the at least one third inlet (8).

8. Apparatus according to claim 1 wherein the burner part (11) comprises a plasma gas inlet connected to a source of plasma gas and a plasma gas cutlet, wherein the plasma gas outlet opens into the reactor chamber (2); and
wherein the inlet (5) of the hydrocarbon fluid is oriented towards the inlet for plasma gas, such that the hydrocarbon fluid and the plasma gas mix closely when entering into the reaction chamber (2).

9. Apparatus according to claim 1, wherein the plasma burner (7) comprises at least two elongated electrodes, wherein each thereof has a base part (9) at one end, the base part being mounted to the reactor wall (3, 3a, 3b), and wherein the burner part (11) is located at the end opposite to the base part and extends into the reactor chamber (2).

10. Method for producing synthesis gas comprising the following steps:
supplying a hydrocarbon fluid into a reaction chamber (2) which comprises at least one inlet (5) for hydrocarbon fluid and at least one outlet (15);
generating a fluid flow from the inlet (5) to the outlet (15);
decomposing the hydrocarbon fluid into carbon particles and hydrogen with the aid of a plasma burner (7) which is located between the inlet (5) and the outlet (15); and
mixing the carbon particles and the hydrogen with CO₂ or H₂O in a region of the reactor chamber (2) where between 90% and 95% of the hydrocarbon fluid is thermally decomposed.

11. Method according to claim 10, wherein the step of mixing the CO₂ or H₂O is carried out, with respect to the fluid flow, after the plasma burner (7) in a region of the reactor chamber (2) where the carbon particles have a size of equal to or less than 250 nm and preferably of equal to or less than 100 nm.

12. Method according to claim 10, wherein the step of mixing with CO₂ or H₂O is carried out, with respect to the fluid flow, after the plasma burner (7) in a region of the reactor chamber (2) where a temperature of 1550 to 1800° C. prevails.

13. Method according to on claim 10, wherein the step of mixing with CO₂ and mixing with H₂O are carried out separately and one after another with respect to the fluid flow.

14. Method according to claim 10, wherein the pressure in the reactor chamber (2) is set to 10 to 24 bar.

15. Method according to claim 10, wherein the synthesis gas has an amount of residual or not decomposed hydrocarbon fluid in a range of 1.25 to 2.5 mol % in the region of the outlet (15).

16. Apparatus according to claim 1, wherein the plasma burner (7) is located outside the reactor chamber (2) and is connected to the reactor chamber via an opening in the reactor wail (3, 3a, 3b), wherein the burner part (11) is oriented towards the opening such that the plasma gas is directed into the reaction chamber (2).
